(19) United States
(12) Patent Application Publication
(10) Pub. No.: US 2012/0096310 A1
(43) Pub. Date: Apr. 19, 2012

(54) REDUNDANCY LOGIC

(75) Inventors: Surya Prakash Varanasi, Dublin, CA (US); Kung-Ling Ko, Union City, CA (US); Satsheel B. Altekar, San Jose, CA (US); Venkata Pramod Balakavi, San Jose, CA (US)

(73) Assignee: BROCADE COMMUNICATIONS SYSTEMS, INC., San Jose, CA (US)

(21) Appl. No.: 12/906,339

(22) Filed: Oct. 18, 2010

(51) Int. Cl. G06F 11/14; G06F 11/07

(52) U.S. Cl. 714/15; 714/E11.024; 714/E11.117

(57) ABSTRACT

A network system provides network device having a secondary memory that mirrors the content of a primary memory maintaining data structure parameters entries. The integrity of each data structure parameter entry is tested as the entry is output from the primary memory, such as by using a parity test. If an error is detected in the entry, a corresponding entry from the second memory structure is select for use instead of the entry from the primary memory. The corresponding entries in each memory are then flushed, updated, synchronized, or overwritten from the each memory and processing continues using the new entries or other entries from the primary memory. In the rare instance that corresponding entries from both memories exhibit an error, then an error notification is issued.

### BACKGROUND

Flexible data structures, such as linked lists, are used in a variety of applications. Linked lists are typically implemented as a collection of data items and associated data structure parameters (e.g., pointers). For example, a linked list may also be used to implement a first-in, first-out (FIFO) queue for managing data packets in a communications device. Linked lists can be used to implement other important abstract data structures, such as stacks and hash tables.

An example benefit of linked lists over common data arrays is that a linked list can provide a prescribed order to data items that are stored in a different or arbitrary order. Furthermore, linked lists tend to allow more flexible memory usage, in that data items can be referenced and reused by multiple linked lists, rather than requiring static allocation of sufficient memory for each list.

In a communications device responsible for transmitting packets, for example, link lists may be used to implement transmit queues. However, memory in which the data structure parameters are stored are subject to failure. For example, a bit to be stored in the memory with a value of ‘1’ may revert to a ‘0’ via a hardware failure and result in a corruption of the linked list. In most cases, communications within the network can be disrupted for an extended period of time as the communications chip managing the corrupted transmit queue is reset and potentially as other aspects of the network are also reset or updated. Such disruptions are becoming increasingly unacceptable for modern communication expectations.

### SUMMARY

Implementations described and claimed herein address the foregoing problems by providing a secondary memory that mirrors the content of a primary memory maintaining data structure parameters. The integrity of each data structure parameter entry is tested as the entry is output from the primary memory, such as by using a parity test. If an error is detected in the entry, a corresponding entry from the second memory structure is selected for use instead of the entry from the primary memory. The corresponding entries in each memory are then flushed, updated, synchronized, or overwritten from the each memory and processing continues using the new entries or other entries from the primary memory. In the rare instance that corresponding entries from both memories exhibit an error, then an error notification is issued.

Other implementations are also described and recited herein.

### BRIEF DESCRIPTIONS OF THE DRAWINGS

FIG. 1 illustrates an example network implementing redundant queuing.

FIG. 2 illustrates an example set of data structures implementing a queue using data structure parameters.

FIG. 3 illustrates an example redundancy circuit.

FIG. 4 illustrates example queuing logic using redundancy circuitry.

FIG. 5 illustrates example operations for processing one or more frames employing redundant queuing.

FIG. 6 illustrates an example switch architecture configured to implement redundant queuing.

### DETAILED DESCRIPTIONS

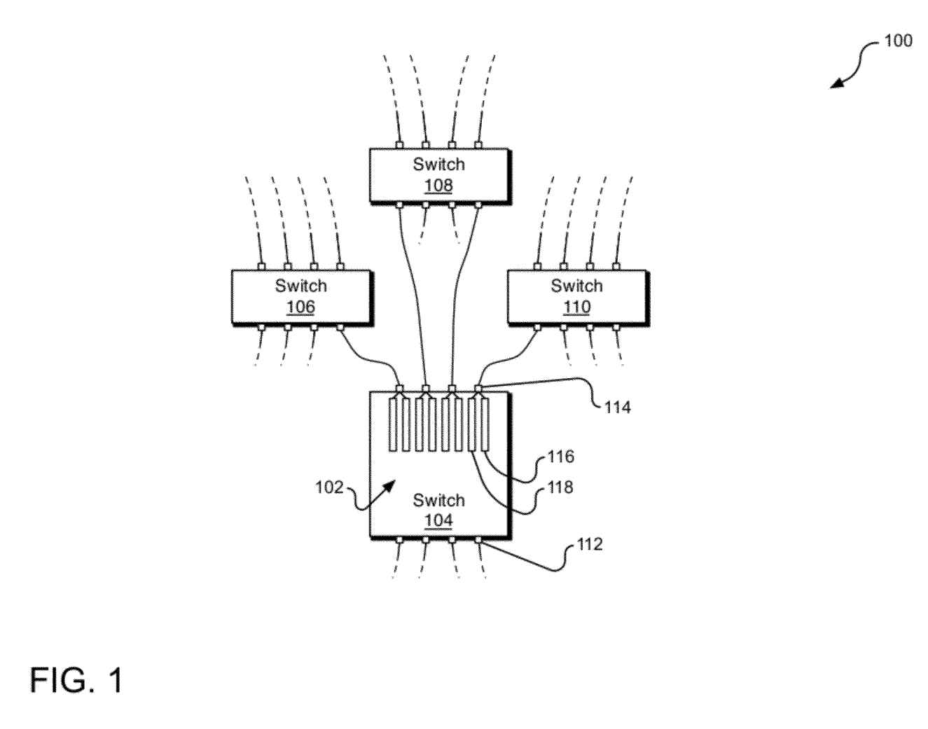

FIG. 1 illustrates an example network 100 implementing redundant queuing. A switch device 104 is communicatively coupled to switches 106, 108, and 110 in the network 100. The switch device 104 includes one or more circuits (e.g., application specific integrated circuits or ASICs) that manage the traffic through the switch device 104. In one implementation, each such circuit is capable of receiving packets from ingress ports of the switch device 104 and inserting each packet in an appropriate queue for transmission from an egress port of the switch device 104.

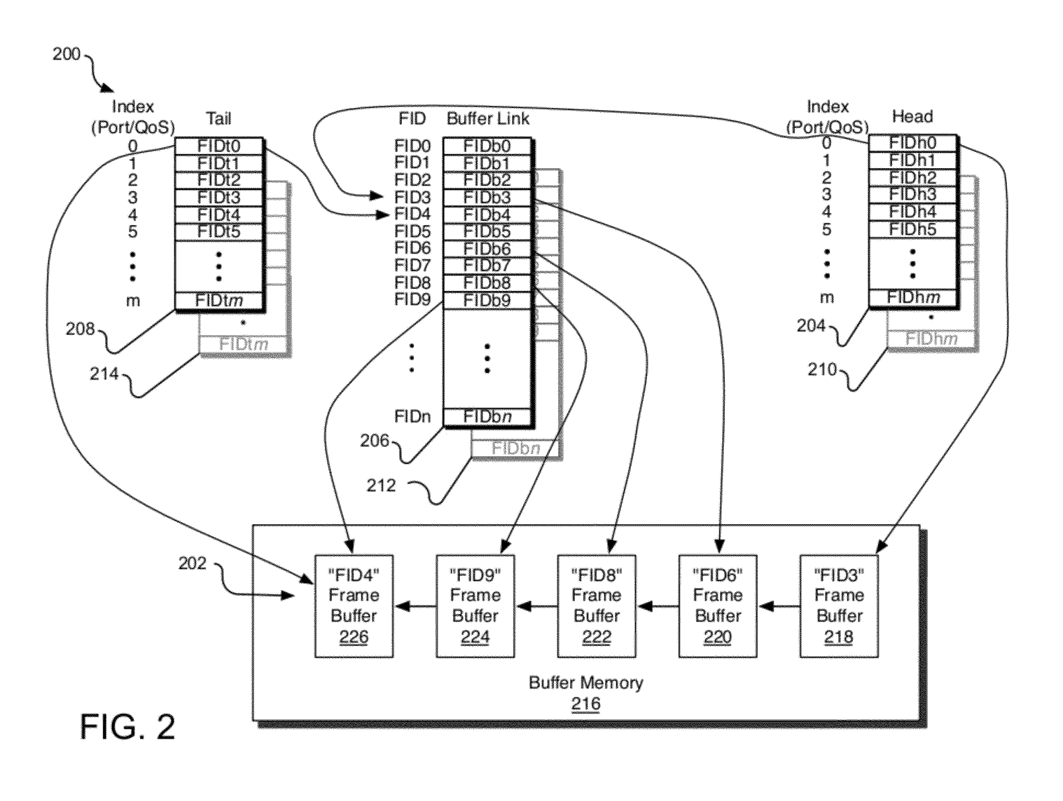

For purposes of explaining the data flow, assume data traffic enters switch 104 as an ingress port 112 and exits via an egress port 114 for transmission to the switch 110. Data to be transmitted from the egress port 114 to the switch 110 is queued until it is actually transmitted. The data structures parameters (e.g., head, link, and tail pointers) that implement a transmit queue structure are stored in memory (as shown generally at 102) for each egress port (see the description regarding FIG. 2). It should be understood that the parameters can represent descriptors for various types of abstract data structures including queues, linked lists, stacks, hash tables, state machines, etc.

In one implementation, the data structure parameters point to buffers storing transmit data and/or other data structure parameters, and queue management logic (not shown in FIG. 1) uses the data structure parameters to manage the transmit queue. As shown in FIG. 2, an example queue 202 is shown in a buffer memory 216 and includes frame buffers 218, 220, 222, 224, and 226, each of which contain a received packet that is queued for transmission from an egress port.

Memory storing the data structure parameters is subject to errors (e.g., as identified by a parity error), which can corrupt management of the transmit queue. (Errors in frame data can be handled via the communications protocol in most circumstances). If an incorrect data structure parameter is used in managing the transmit queue, the queue may need to be flushed and communications through the queue may need to be reset in order to recover from the error. Accordingly, in the described technology, the switch 104 includes redundant memories, primary memory 116 and secondary memory 118, for storing mirrored representations of the data structure parameters that manage the transmit queue for the port 114. In this manner, if an error is detected in the primary memory 116, then corresponding data from the secondary memory 118 may be used instead, avoiding corruption of the transmit queue. After the correct data is used from the secondary memory 118, the error in the primary memory 116 and the correct data in the secondary memory 118 are overwritten with a new data structure parameter and processing proceeds with using the primary memory 116 until another error is detected.

In rare circumstances, errors are detected for corresponding data in both the primary memory 116 and the secondary memory 118. In such cases, the queue management logic aborts the typical data processing and issues an error.

FIG. 2 illustrates an example set 200 of data structures implementing a queue 202 using data structure parameters. In the illustration of FIG. 2, the set 200 includes a subset of data structures in primary memories (a primary head data structure 204, a primary buffer link data structure 206, and a primary tail data structure 208) and another subset of data structures in secondary memories (a secondary head data structure 210, a secondary buffer link data structure 212, and a secondary tail data structure 214), each data structure storing a plurality of data structure parameters for implementing the queue 202. It should be understood that the primary and secondary memories and the data structures stored therein represent logical allocations of memory and may be embodied in a single memory or distributed over multiple memory modules.

As frames are received at ingress ports, they are forwarded to queue management logic, which inserts the frames in appropriate transmit queues. The queue management logic inserts the frame into a queue associated with the egress port to which the frame is destined (based on routing parameters in the frame and switch) and with the QoS level of the frame. For example, the primary head list 204 and the primary tail list 208 are indexed according to the egress ports and quality of service (QoS) levels combinations supported in the switch device (the maximum of which is represented by the variable m in FIG. 2). In one implementation, m is computed based on 48 egress ports and 32 QoS levels to equal 1536, although other characteristics and combinations thereof may be employed. For the purposes of further illustration, the queue 202 is associated with a first port/QoS level combination (designated as index “0”). Each frame received for this same port/QoS level combination is stored in a frame buffer in the buffer memory 216, as shown by the linked list of frame buffers 218, 220, 222, 224, and 226.

Each entry in the primary head list 204 and the primary tail list 208 stores a variable value representing a Frame Identifier or FID to a frame buffer in a buffer memory 216. The index associated with each entry in the head and talk lists represents port/QoS level combination. The notation “FIDt0” represents an FID pointer variable stored at the zero^{th} index entry of the tail list 208, and the notation “FIDh0” represents an FID pointer variable stored at the zero^{th} index entry of the head list 204. Each FID variable value in the head and tail lists points to a frame buffer in the buffer memory 216, wherein the next frame for transmission from the queue 202 is stored in the frame buffer identified by the FID represented by FIDh0 and the most recently received frame in the queue 202 is stored in the frame buffer identified by the FID represented by FIDt0.

Any frames in a queue between the head and the tail are identified by the buffer link list, which defines the “next” frame buffer in the queue relative to a given frame buffer (identified by an FID). In contrast to the head and tail lists, which are sized to manage the maximum port/QoS level combination for the switch device, the buffer link list is sized to manage the maximum number of frame buffers that can be managed by the ASIC and is indexed by the range of supported FIDs. For example, if the ASIC is designed to manage 8K frame buffers, then primary and secondary buffer link lists 206 and 212 are sized to store 8K FIDs (potentially minus the head and tail FIDs, which are stored in the head and tail lists). If the head and tail lists for a given port/QoS level store the same FID value, then the queue associated with that port/QoS level is deemed empty.

In one implementation, the primary buffer management proceeds as described below. (Note: In support of redundancy, each entry in the primary data structure parameter lists is mirrored in the secondary data structure parameter lists.) It should be understood that other methods of buffer management may also be employed in combination with redundancy logic.

Prior to the scenario presented in FIG. 2, the frame buffer sequence in the queue 202 is FID3->FID6->FID8->FID9, wherein FID3 is the head frame buffer in the queue and FID9 is the tail frame buffer in the queue 202. Then a frame is received and stored in frame buffer 226, identified by FID4, and sent to the queue management logic.

To “enqueue” the new frame, the queue management logic read the FID stored in the zero^{th} entry of the tail list 208, which at the time was “FID9”, writes FID4 into the FID9 location of the buffer link list 206, and then writes FID4 into the zero^{th} entry of the tail list 208.

In this manner, the frame buffer sequence in the queue 202 is extended to FID3->FID6->FID8->FID9->FID4 to reflect receipt of a new frame into the queue 202, wherein FID3 is the head frame buffer in the queue and FID4 is now the tail frame buffer in the queue 202.

To “dequeue” a frame from the queue 202, the queue management logic reads the FID value stored in the zero^{th} entry of the head list 204 (“FID3”), transmits the frame stored in the identified frame buffer, and copies the FID value stored in the FID3 location of the buffer link list 206 (“FID6”) into the zero^{th} entry of the head list 204. In this manner, the frame buffer sequence in the queue 202 is reduced to FID6->FID8->FID9->FID4 to reflect the transmission of the frame at the head of the queue 202, wherein FID6 is the head frame buffer in the queue and FID4 is the tail frame buffer in the queue 202.

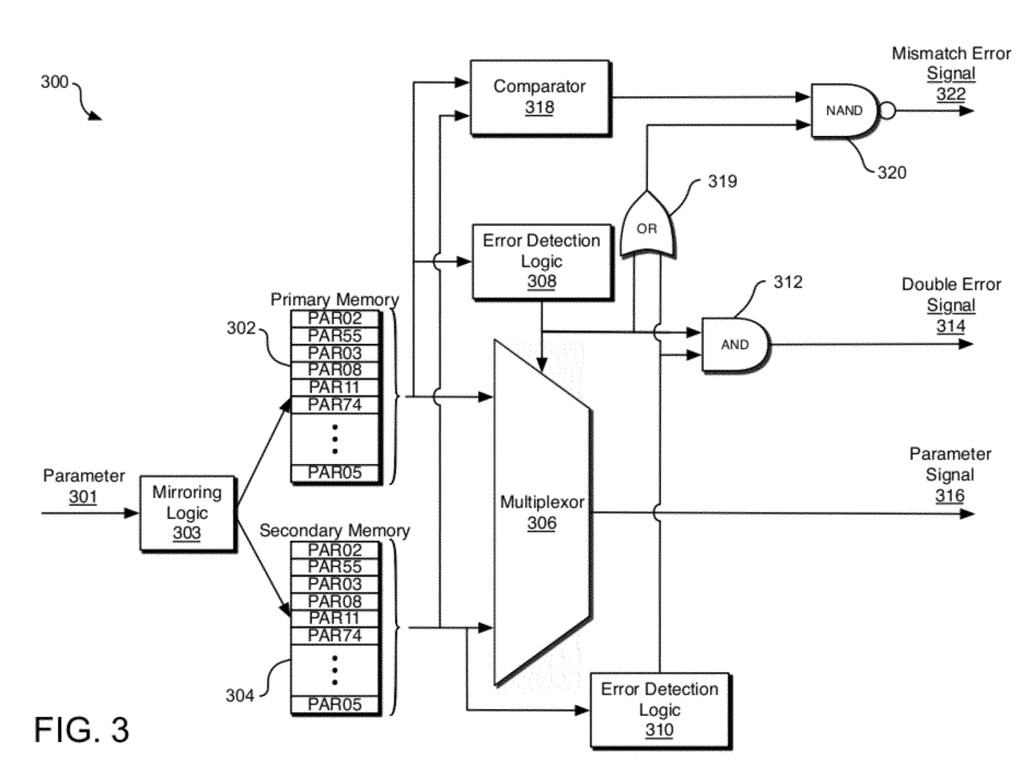

FIG. 3 illustrates an example redundancy circuit 300, including a primary memory 302 and a secondary memory 304. It should be understood that such memories may be embodied in random access memory (RAM) and allocated in or across different memory modules. Likewise, such memories may be embodied in the same memory module. As new data structure parameters are received, the memories are updated and mirrored, such that the same data structure parameter 301 is written to each memory via mirroring logic 303, typically at the same location in the memories (although it is possible for the internal data structures of the memories to be different, so long as the corresponding mirrored data is available from each memory).

Under certain circumstances, the data written to a memory may be corrupted. For example, in a write of a data structure parameter to the memory, a “1” bit that is written to the memory may not write correctly and the bit is recorded as a “0” bit. There are a variety of methods for detecting such errors, including the use of parity bits, repetition codes, or checksums.

When data structure parameters are needed to process the corresponding data structure (e.g., to enqueue or to dequeue an entry in the queue), both memories output corresponding entries. As illustrated in FIG. 3, outputs of both the primary memory 302 and the secondary memory 304 are coupled to output data structure parameters to a multiplexor 306. For example, in a switch device, assume the memories store head pointers of queues associated with transmit ports, as discussed with regard to FIG. 2. When the switch device attempts to dequeue a frame from the queue, the queue management logic of the switch device outputs the corresponding head pointers from the primary and secondary memories 302 and 304 and inputs them to the multiplexor 306.

Error detection logic 308 is coupled to receive the output of the primary memory 302, to test the integrity of the data structure parameter entries, and to send an error signal to the multiplexor 306 in a lack of integrity is detected (e.g., a parity error). Using the error signal, the error detection logic 308 operates as a selector for the multiplex 306. If the data structure parameter output from the primary memory 302 is detected to have an error by the error detection logic 308, then the error signal will select the output of the multiplexor 306 to be the output of the secondary memory 304 instead of the output of the primary memory 302. In this manner, in response to detection of an error in the output of the primary memory 302, the multiplexor 306 outputs the parameter provided by the secondary memory 304, which is statistically unlikely to have an error in the same parameter entry.

However, in some circumstances, the parameters output from both the primary memory 302 and the secondary memory 304 have errors. In such circumstances, although rare, error detection logic 310 detects the error from the secondary memory 304 and issues an error signal to a Boolean AND logic gate 312 (or its equivalent), which also receives the error signal from the error detection logic 308. If both errors signals indicate an error in the parameter, then a double error signal output 314 is output indicating a double error has been detected (i.e., errors in both copies of the parameter). The ASIC and the switch device can respond appropriately to reset the communications channel, and if necessary, the network.

If a double error is not detected in the parameter output from either the primary memory 302 or the secondary memory 304, then the parameter output from the multiplexor 306 via the parameter signal output 316 is deemed usable in the management of the queue. In this manner, the switch device can continue to perform uninterrupted because at least one correct parameter was available and this correct parameter was output for use by the queue management logic.

In addition, in some circumstances, the redundancy circuit 300 may experience an error in corresponding entries in both the primary memory 302 and the secondary memory 304, yet neither entry individually exhibits a detectable error, such as a parity error. To address this event, an implementation may include a comparator 318, which inputs and compares the corresponding entries from each memory 302 and 304 and outputs a comparison result (e.g., 0 if equal; 1 if not equal). A “not equal” result suggests a possible mismatch error between the corresponding entries. However, when there is an error detected in only one of the entries, then the entries are expect to be unequal. As such, the outputs of the error detection logic 308 and 310 are combined using a Boolean OR gate 319, the output of which is input to the Boolean NAND gate 320 along with the output of the comparator 318. If there is no error detected in either entry but the comparator 318 determines that the entries are unequal, the Boolean NAND gate 318 outputs a “1” to signal the mismatch error (via mismatch error signal output 322). In contrast, if there is an error detected in one or both entries and the comparator 318 determines that the entries are unequal, the Boolean NAND gate 320 outputs a “0” to signal that there is no mismatch error (via mismatch error signal output 322).

In this implementation with a mismatch test, the error outputs may be combined with a Boolean AND gate (not shown) so that a single error signal is generated to trigger a reset to the network device. Alternatively, both error signals can be evaluated independently or in combination to provide additional diagnostic information.

In various implementations, the multiplexor 306, the error detection logic 308 and 310, the Boolean logic gates 312, 319, and 320, and the comparator 318 represent management logic for the redundancy circuit 300, although other combinations of logic may comprise management logic in other implementations. For example, one implementation of management logic may omit the mismatch error logic (e.g., the comparator 318 and logic 318 and 320). In another example, alternative Boolean logic gate combinations may be employed.

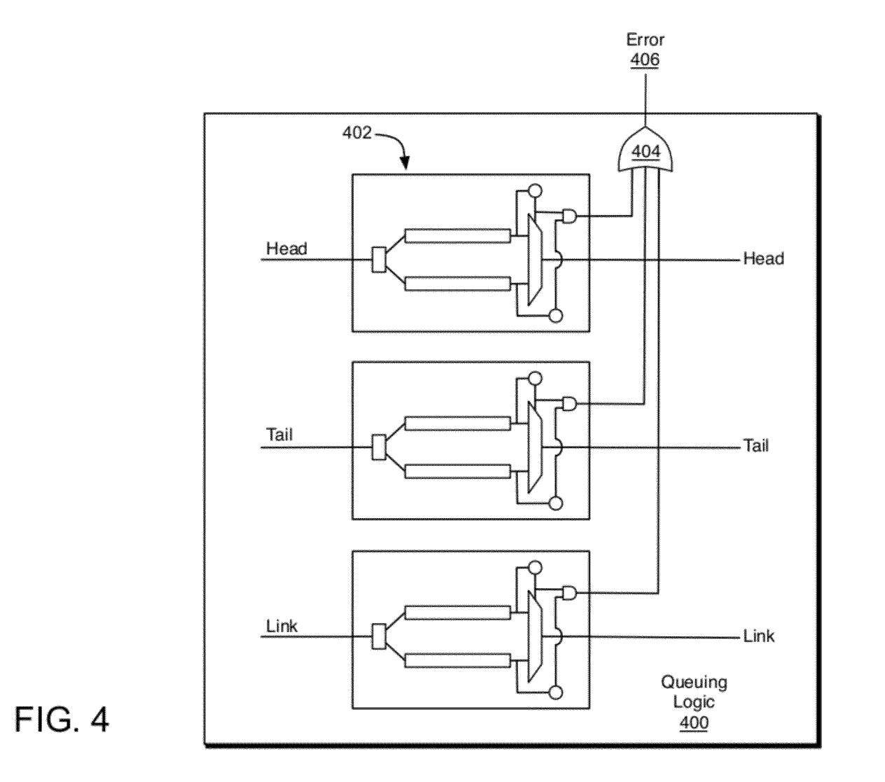

FIG. 4 illustrates example queuing logic 400 using redundancy circuitry 402. In the example of FIG. 4, the queuing logic 400 is represented as operating in an ASIC of a switch device, although it should be understood that similar logic (e.g., circuitry, or software and circuitry) may be employed to manage data structures in any device.

As frames are received via the ingress ports of the switch device, they are loaded into a frame buffer in buffer memory and the FID of that frame buffer is forwarded to the queuing logic 400 to manage the transmit queue. When enqueuing a frame, the queuing logic 400 updates the head, tail, and buffer link values for the queue, as appropriate, using the FID of the new frame buffer. Likewise, when dequeueing a frame, the queuing logic 400 updates the head, tail, and buffer link values for the queue, as appropriate, to indicate the removal of the frame buffer for the transmitted frame. Typically, this frame buffer is inserted into a “free” queue of available frame buffers to store a subsequently received frame. Redundancy logic may also be used in managing the data structure parameters of the free buffer queue.

As shown, the error signals of each redundancy circuit 402 are logically combined using a Boolean OR gate 404 or some similar operational logic. In this illustrated implementation, gate 404 outputs an error signal 406 if any of the redundancy circuits 402 generate a double error signal indicating that both the primary memory and the secondary memory for the redundancy circuit had errors for the entry of interest. As such, an error signal 406 may trigger a reset of the ASIC, the switch device, and/or other parts of the network (e.g., updating routing tables in other switches, revising zoning tables, etc.).

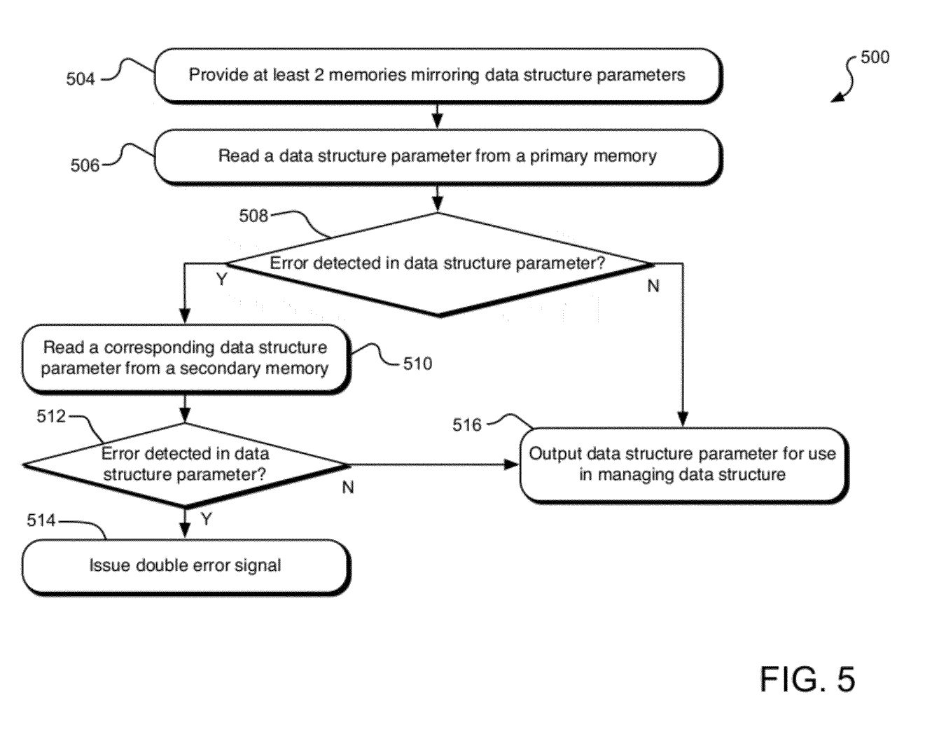

FIG. 5 illustrates example operations 500 for processing one or more frames employing redundant queuing. A providing operation 504 provides at least 2 memories mirroring data structure parameters for managing an underlying data structure (e.g., a transmit queue), one memory being designated as a primary memory and another memory being designated as a secondary memory. As data structure parameters are added to the memory (e.g., a head pointer list, a tail pointer list, a buffer link pointer list), each data structure is written to both the primary memory and the secondary memory, resulting in the mirroring of data structure parameters in each memory.

A reading operation 506 reads a data structure parameter from the primary memory (e.g., corresponding to a port of interest or an FID, as described with regard to FIG. 2). A decision operation 508 determines whether an error is detected in the data structure parameter that has been read from the primary memory (e.g., via a parity check). If not, then the data structure parameter read from the primary memory is output in an output operation 516 for use in managing the underlying data structure.

If, however, an error is detected in the decision operation 508, another read operation 510 reads a corresponding data structure parameter from the second memory, which contains a mirrored set of data structure parameters. Another decision operation 512 determines whether an error is detected in the data structure parameter that has been read from the secondary memory (e.g., via a parity check). If not, then the data structure parameter read from the secondary memory is output in an output operation 516 for use in managing the underlying data structure. If, however, an error is detected in the decision operation 512, an error operation 514 generates a double error signal.

In an alternative implementation that supports a mismatch error test, corresponding entries may be compared in a comparison operation (not shown, but see the comparator 318 in FIG. 3). Unless there are been an error detected in either of the corresponding entries (e.g., a parity error), then a comparison result indicating that the corresponding entries are unequal signifies that there is an undetected error in one of the entries, which may be signal as a mismatch error.

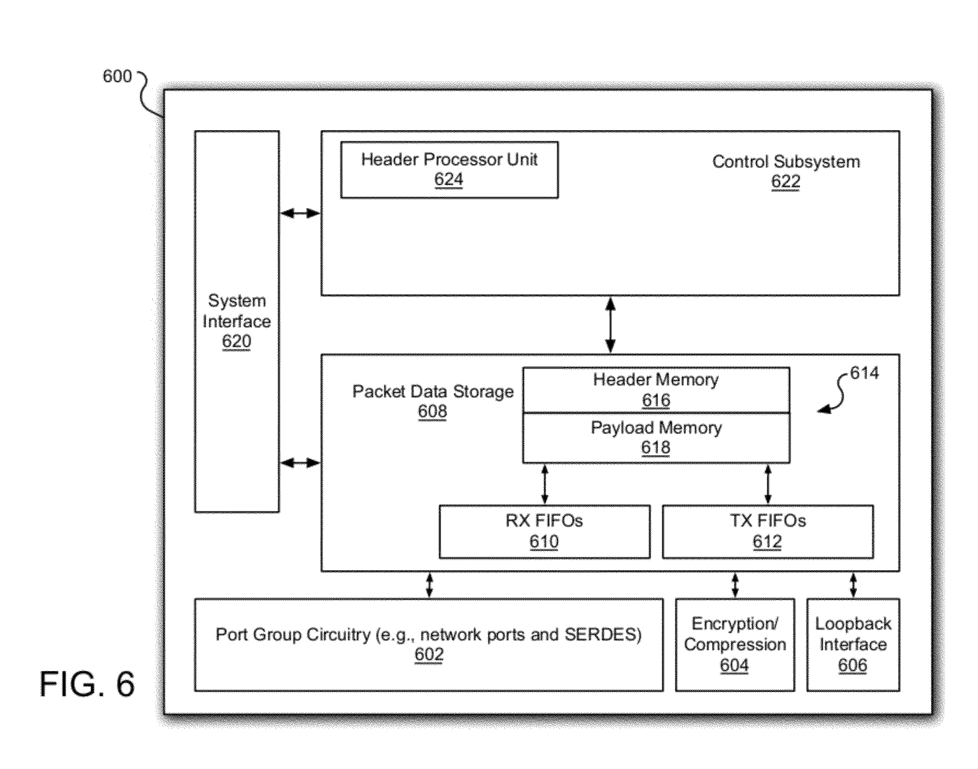

FIG. 6 illustrates an example switch architecture 600 configured to implement redundant queuing. In the illustrated architecture, the switch represents a Fibre Channel switch, but it should be understood that other types of switches, including Ethernet switches, may be employed. Port group circuitry 602 includes the Fibre Channel ports and Serializers/Deserializers (SERDES) for the network interface. Data packets are received and transmitted through the port group circuitry 602 during operation. Encryption/compression circuitry 604 contains logic to carry out encryption/compression or decompression/decryption operations on received and transmitted packets. The encryption/compression circuitry 604 is connected to 6 internal ports and can support up to a maximum of 65 Gbps bandwidth for compression/decompression and 32 Gbps bandwidth for encryptions/decryption, although other configurations may support larger bandwidths for both. Some implementations may omit the encryption/compression 604. A loopback interface 606 is used to support Switched Port Analyzer (SPAN) functionality by looping outgoing packets back to packet buffer memory.

Packet data storage 608 includes receive (RX) FIFOs 610 and transmit (TX) FIFOs 612 constituting assorted receive and transmit queues, one or more of which includes mirrored memories and is managed handled by redundancy logic. The packet data storage 608 also includes control circuitry (not shown) and centralized packet buffer memory 614, which includes two separate physical memory interfaces: one to hold the packet header (i.e., header memory 616) and the other to hold the payload (i.e., payload memory 618). A system interface 620 provides a processor within the switch with a programming and internal communications interface. The system interface 620 includes without limitation a PCI Express Core, a DMA engine to deliver packets, a packet generator to support multicast/hello/network latency features, a DMA engine to upload statistics to the processor, and top-level register interface block.

A control subsystem 622 includes without limitation a header processing unit 624 that contains switch control path functional blocks. All arriving packet descriptors are sequenced and passed through a pipeline of the header processor unit 624 and filtering blocks until they reach their destination transmit queue. The header processor unit 624 carries out L2 Switching, Fibre Channel Routing, LUN Zoning, LUN redirection, Link table Statistics, VSAN routing, Hard Zoning, SPAN support, and Encryption/Decryption.

A network switch may also include one or more processor-readable storage media encoding computer-executable instructions for executing one or more processes of dynamic latency-based rerouting on the network switch. It should also be understood that various types of switches (e.g., Fibre Channel switches, Ethernet switches, etc.) may employ a different architecture that that explicitly describe in the exemplary implementations disclosed herein.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A system comprising:
a first memory configured to store data structure parameter entries;
a second memory configured to store the data structure parameter entries in a mirrored order relative to the data structure parameter entries in the first memory; and
management logic coupled to the first and second memories and configured to output a data structure parameter entry from the first memory, if the data structure parameter entry does not have an error, and to output a corresponding data structure parameter entry from the second memory, if the data structure parameter entry from the first memory has an error.

2. The system of claim 1 wherein the management logic is further configured to generate a double error signal if the data structure parameter entry from the first memory has an error and the corresponding data structure parameter entry from the second memory has an error.

3. The system of claim 1 wherein the management logic is further configured to generate a mismatch error, if neither the data structure parameter entry and the corresponding data structure parameter entry have an error individually and the data structure parameter entry and the corresponding data structure parameter entry are unequal.

4. The system of claim 1 further comprising:
mirroring logic coupled to the first and second memories and configured to store the data structure parameter entries in the mirrored order in the first and second memories.

5. The system of claim 1 wherein the management logic comprises:
a multiplexor coupled to the first and second memories and configured to output either the data structure parameter entry or the corresponding data structure parameter entry, conditional on detection of the error.

6. The system of claim 1 wherein the management logic comprises:
error detection logic configured to detect an error in the data structure parameter entry and select an output of the management logic, conditional on detection of the error.

7. The system of claim 1 wherein the data structure parameter entry represents a descriptor of an abstract data structure.

8. The system of claim 1 wherein the data structure parameter entries represent first descriptors of a data structure, and further comprising:
an additional mirrored memory pair and management logic operating on a second set of data structure parameter entries representing second descriptors of the data structure.

9. A method comprising:
storing data structure parameter entries a first memory and a second memory in a mirrored order;
outputting a data structure parameter entry from the first memory, if the data structure parameter entrydoes not have an error; and
outputting a corresponding data structure parameter entry from the second memory, if the data structure parameter entry from the first memory has an error.

10. The method of claim 9 further comprising:
issuing a double error signal, if the data structure parameter entry from the first memory has an error and the corresponding data structure parameter entry from the second memory has an error.

11. The method of claim 9 further comprising:
issuing a mismatch error, if neither the data structure parameter entry and the corresponding data structure parameter entry have an error individually and the data structure parameter entry and the corresponding data structure parameter entry are unequal.

12. The method of claim 9 further comprising:
outputting either the data structure parameter entry or the corresponding data structure parameter entry, conditional on detection of the error.

13. The method of claim 9 further comprising:
detecting an error in the data structure parameter entry.

14. The method of claim 13 further comprising:
selecting an output of the management logic, conditional on detection of the error.

15. The method of claim 9 wherein the data structure parameter entry represents a descriptor of an abstract data structure.

16. The method of claim 9 wherein the data structure parameter entries represent first descriptors of a data structure and further comprising:
storing, in another first memory and another second memory in a mirrored order, data structure parameter entries representing second descriptors of the data structure; and
outputting from the other first memory a data structure parameter entries representing a second descriptor, if the data structure parameter entry representing a second descriptor does not have an error; and
outputting from the other second memory a corresponding data structure parameter entries representing the second descriptor, if the data structure parameter entry from the other first memory has an error.

17. A system comprising:
first and second memories configured to mirror data structure parameter entries representing descriptors of a data structure; and
one or more selectors configured to select a data structure parameter entry for output from the first memory, if the data structure parameter entry does not have an error, and to select a corresponding data structure parameter entry for output from the second memory, if the data structure parameter entry from the first memory has an error.

18. The system of claim 17 wherein the one or more selectors include error detection logic configured to test integrity of the data structure parameter entry.

19. The system of claim 17 further comprising:
logic coupled to the error detection logic and configured to generate a double error signal, if the data structure parameter entry from the first memory has an error and the corresponding data structure parameter entry from the second memory has an error.

20. The system of claim 17 further comprising:
comparison logic coupled to the first and second memories and configured to generate a mismatch error, if neither the data structure parameter entry and the corresponding data structure parameter entry have an error individually and the data structure parameter entry and the corresponding data structure parameter entry are unequal.
